(19) United States
(12) Patent Application Publication
(10) Pub. No.: US 2008/0087298 A1
(43) Pub. Date: Apr. 17, 2008

(54) Method and apparatus for cleaning magnetic head slider, and method for manufacturing the same

(75) Inventors: Takahiro Katou, Kanagawa (JP); Hiroshi Yuyama, Kanagawa (JP); Kentaro Namikawa, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V, Amsterdam, AZ (US)

(21) Appl. No.: 11/903,297

(22) Filed: Sep. 21, 2007

(30) Foreign Application Priority Data
Sep. 21, 2006 (JP) 2006-256083

(51) Int. Cl. B08B 3/12; B08B 13/00

(52) U.S. Cl. 134/1; 134/85

(57) ABSTRACT

Embodiments of the present invention provide a method and an apparatus for cleaning a magnetic head slider, and a method for manufacturing the same, which can achieve a magnetic head slider having high cleanness. According to one embodiment, in a rinsing process, a magnetic head slider is accommodated within a receptacle portion formed in a receptacle tray and the receptacle tray is immersed into rinsing liquid and is moved therein. As a result, the magnetic head slider receives a lifting force from the rinsing liquid which has entered the receptacle portion from through holes, so it flies over and at the same time receives water pressure from the rinsing liquid. Consequently, it is possible to effect rinsing to a satisfactory extent.

### CROSS-REFERENCE TO RELATED APPLICATION

The instant nonprovisional patent application claims priority to Japanese Patent Application No. 2006-256083 filed Sep. 21, 2006 and which is incorporated by reference in its entirety herein for all purposes.

### BACKGROUND OF THE INVENTION

For today's magnetic disk drive, the reduction of the device size and an increase of the storage capacity have been made rapidly, and the flying height, from a magnetic disk, of a magnetic head slider which holds a head for the storage and reproduction of data has been decreased to about 10 nm or less.

If dust, a gasified organic matter or any other contaminant adheres to the magnetic head slider in the magnetic disk drive, the reliability in sliding resistance between the magnetic head slider and the magnetic disk may be deteriorated. Therefore, high cleanness is required for the magnetic head slider.

Therefore, the magnetic head slider is subjected to cleaning in the final manufacturing stage. Generally, the cleaning comprises a cleaning step of washing off the contaminant adhering to the magnetic head slider with use of a cleaning solution, a rinsing step of washing off the adhering cleaning solution with rinsing liquid, and a drying step of drying the resulting adhering rinsing liquid.

However, in the case of cleaning such a very small and easy-to-damage part as the magnetic head slider, it is necessary to perform cleaning and rinsing in a state in which the magnetic head slider is accommodated within a tray or the like. Consequently, the cleaning and rinsing become insufficient, making it difficult to attain high cleanness.

For example, Japanese Patent Publication No. 4-29787 (“Patent Literature 1”) discloses a cleaning method involving accommodating a part to be cleaned within a cleaning basket, stacking such cleaning baskets in plural stages, immersing the baskets in this state into a cleaning solution stored in a cleaning vessel, and cleaning the to-be-cleaned part with an ultrasonic wave while allowing the part to swing. In this cleaning method, however, since the magnetic head slider stays substantially in one place within the cleaning vessel, unevenness in cleaning performance is apt to occur due to the influence of variations in strength distribution of the ultrasonic wave which depends on the layout position of an ultrasonic wave oscillator and also due to the influence of variations in strength distribution of the ultrasonic wave which is attributable to the formation of a standing wave. Moreover, since cleaning baskets are stacked in plural stages, the ultrasonic wave is apt to be shielded by other cleaning baskets and thus here again unevenness in cleaning performance is apt to occur. As a result, cleaning becomes insufficient, making it difficult to attain high cleanness.

Japanese Patent Publication No. 2005-158132 (“Patent Literature 2”) discloses a cleaning method involving cleaning a part to be cleaned with use of a cleaning solution and an ultrasonic wave, then immersing it into a rinsing vessel which stores pure water as rinsing liquid, and rinsing the part with an ultrasonic wave. According to this cleaning method, however, there sometimes is a case where a contaminant may be generated from a cleaning vessel or a tray and adhere to a magnetic head slider as the part to be cleaned without being dispersed within pure water. Besides, air bubbles are apt to be formed within pure water under the radiation of the ultrasonic wave and the air bubbles thus formed within pure water may close an opening which communicates with a receptacle portion of the receptacle tray, making it difficult for the pure water to enter the receptacle portion. As a result, rinsing becomes insufficient and it is difficult to attain high cleanness.

### BRIEF SUMMARY OF THE INVENTION

Embodiments in accordance with the present invention provide a method and an apparatus for cleaning a magnetic head slider, and a method for manufacturing the same, which can achieve a magnetic head slider having high cleanness. According to the particular embodiment of FIG. 4, in a rinsing process, a magnetic head slider 15 is accommodated within a receptacle portion formed in a receptacle tray 14 and the receptacle tray 14 is immersed into rinsing liquid and is moved therein. As a result, the magnetic head slider 15 receives a lifting force from the rinsing liquid which has entered the receptacle portion from through holes 11b and 12b, so it flies over and at the same time receives water pressure from the rinsing liquid. Consequently, it is possible to effect rinsing to a satisfactory extent.

### BRIEF DESCRIPTION OF THE DRAWINGS

FIG. 1 is an explanatory diagram of a magnetic head slider manufacturing process.

FIG. 2 illustrates a schematic configuration of a magnetic head slider cleaning apparatus.

FIGS. 3(A)-3(C) illustrate the structure of a receptacle tray.

FIG. 4 illustrates in the state where a magnetic head slider is accommodated within the receptacle tray.

FIGS. 5(A) and 5(B) illustrate the structure of a tray holding element.

FIG. 6 illustrates a cleaning block in the cleaning apparatus.

FIG. 7 illustrates a rinsing block in the cleaning apparatus.

FIG. 8 illustrates the state of the magnetic head slider in a rinsing process.

FIG. 9 illustrates a drying block in the cleaning apparatus.

FIGS. 10(A) and 10(B) illustrate the results of cleaning and rinsing performed by the cleaning apparatus.

### DETAILED DESCRIPTION OF THE INVENTION

Embodiments of the present invention relate to a method and an apparatus for cleaning a magnetic head slider, and a method for manufacturing the same.

Embodiments of the present invention have been accomplished in view of the above-mentioned problems and it is an object of embodiments of the invention to provide a method and an apparatus for cleaning a magnetic head slider, and a method for manufacturing the same, the cleaning method being capable of achieving a magnetic head slider having high cleanness.

To solve the above-mentioned problems, a method for cleaning a magnetic head slider according to embodiments of the present invention comprises a cleaning step of immersing a magnetic head slider in a cleaning solution with ultrasonic vibration applied thereto and a rinsing step of accommodating the magnetic head slider within a receptacle portion of a receptacle tray, the receptacle tray having the receptacle portion for the magnetic head slider and having at least two through holes communicating with the interior of the receptacle portion from the exterior, then immersing the receptacle tray into the rinsing liquid and moving it within the rinsing liquid without applying ultraviolet vibration to the rinsing liquid.

In the magnetic head slider cleaning method according to embodiments of the present invention, in the rinsing step the receptacle tray is moved in a direction intersecting the extending direction of the through holes within the rinsing liquid.

In the magnetic head slider cleaning method according to embodiments of the present invention, in the rinsing step, a procedure of ejecting the rinsing liquid onto the receptacle tray accommodating the magnetic head slider and a procedure of immersing the receptacle tray accommodating the magnetic head slider into the rinsing liquid and moving it within the rinsing liquid are performed in an alternate manner.

In a magnetic head slider cleaning method according to embodiments of the present invention, the cleaning step involves immersing the receptacle tray with the magnetic head slider accommodated therein into the cleaning solution with ultrasonic vibration applied thereto and moving the receptacle tray within the cleaning solution.

A magnetic head slider manufacturing method according to embodiments of the present invention includes any of the magnetic head slider cleaning methods described above.

A magnetic head slider cleaning apparatus according to embodiments of the present invention comprises: a receptacle tray having a receptacle portion for a magnetic head slider and at least two through holes communicating with the interior of the receptacle portion from the exterior; a tray holding element for holding the receptacle tray at a position spaced away from a rotational center of the tray holding element; a cleaning vessel for storing a cleaning solution, an ultraviolet wave oscillator for applying ultrasonic vibration to the cleaning solution stored in the cleaning vessel; a rotating mechanism for cleaning, the rotating mechanism causing the tray holding element holding the receptacle tray to rotate in an immersed state within the cleaning solution stored in the cleaning vessel; a rinsing vessel for storing rinsing liquid; and a rotating mechanism for rinsing, the rotating mechanism causing the tray holder holding the receptacle tray to rotate in an immersed state within the rinsing liquid stored in the rinsing vessel.

A magnetic head slider cleaning apparatus according to embodiments of the present invention further comprises a swing mechanism for cleaning, the swing mechanism causing the tray holding element holding the receptacle tray to swing in an immersed state within the cleaning solution stored in the cleaning vessel in a rotational axis direction of the tray holding element being rotated by the rotating mechanism for cleaning.

A magnetic head slider cleaning apparatus according to embodiments of the present invention further comprises a liquid ejecting mechanism for ejecting the rinsing liquid onto the receptacle tray within the rinsing vessel.

According to embodiments of the present invention described above it is possible to achieve a magnetic head slider having high cleanness.

An embodiment of the present invention will be described below with reference to the drawings.

First, a magnetic head slider manufacturing method according to an embodiment of the present invention will be described.

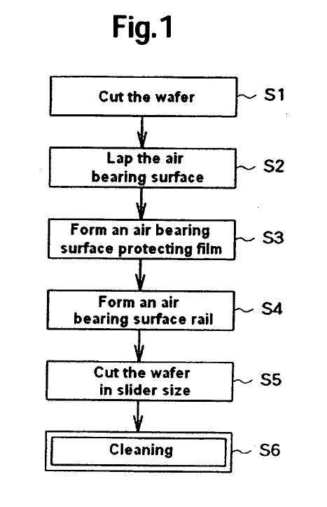

FIG. 1 illustrates a magnetic head slider manufacturing process. In a magnetic head slider manufacturing process, first a wafer fabricated by forming write and read elements on a surface of a ceramic substrate is cut in a rod plate shape by a machining process (S1). Next, the rod plate-like wafer is subjected to lapping to form an air bearing surface which serves as a surface confronting a magnetic disk (S2), a protective film is formed on the air bearing surface in order to prevent corrosion of each exposed element and to improve slidability (S3), and an air bearing surface rail is formed for attaining stable flight (S4). Thereafter, the rod plate-like wafer thus machined is cut into a slider size (S5), followed by final finish cleaning (S6).

Next, a description will be given about an embodiment of a method and an apparatus for cleaning a magnetic head slider. These method and apparatus are applied to the finish cleaning (S6) in the above manufacturing process.

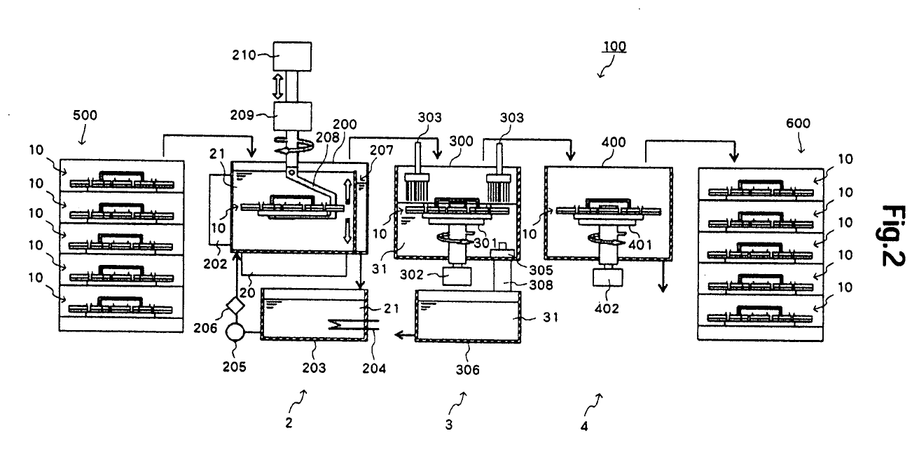

FIG. 2 illustrates a schematic configuration of a magnetic head slider cleaning apparatus 100. The cleaning apparatus 100 can be divided mainly into a cleaning block 2 for washing off any contaminant adhering to a magnetic head slider with use of a cleaning solution 21 stored in a cleaning vessel 200, a rinsing block 3 for washing off the resulting adhering cleaning solution with use of rinsing liquid 31 stored in a rinsing vessel 300, and a drying block 4 for drying the resulting adhering rinsing liquid within a drying vessel 400.

In the cleaning apparatus 100, a magnetic head slider is accommodated within a receptacle tray and a holder 10 which holds a plurality of receptacle trays is handled in each of the blocks 2 to 4. The holder 10 is taken out from a loader 500 which accommodate such holders 10, then is conveyed to the cleaning block 2, rinsing block 3 and drying block 4 in this order and is finally received into an unloader 600.

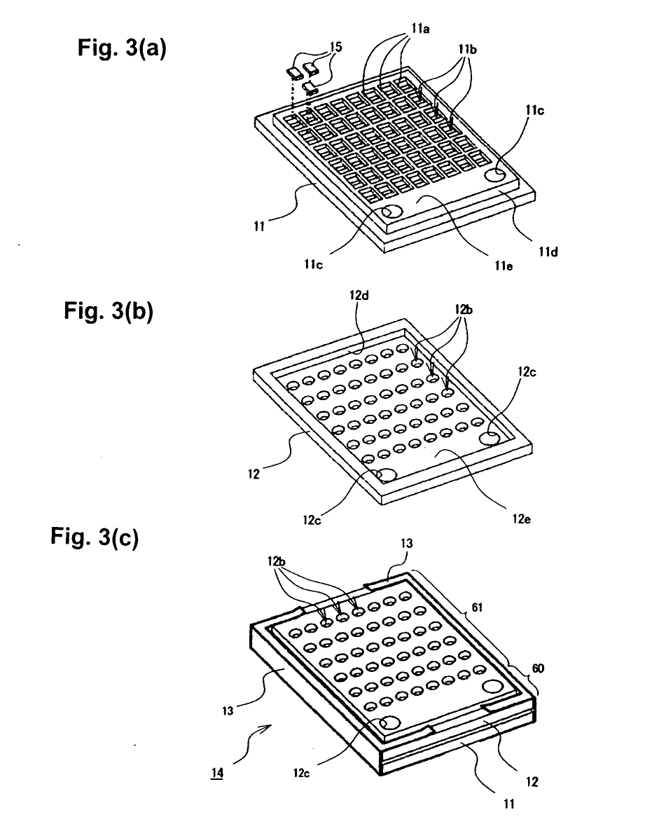

The structure of each receptacle tray will now be described with reference to FIG. 3. FIG. 3(A) illustrates the structure of a tray base 11 serving as part of the receptacle tray. FIG. 3(B) illustrates the structure of a tray cover 12 serving as part of the receptacle tray. FIG. 3(C) illustrates the structure of a receptacle tray 14 as a combination of both tray base 11 and tray cover 12.

The tray base 11 is for accommodating and holding a magnetic head slider 15. The tray base 11 is formed in a plate shape and a large number of recesses partitioned by a lattice-like partitioning portions 11a are formed in a base surface le as a main surface of the tray base located on the side on which the tray base is fitted into the tray cover 12. These recesses each have a size permitting each magnetic head slider 15 to be received therein, thus serving as receptacle spaces for the magnetic head sliders. A through hole 11b is formed in the bottom of each of the recesses formed in the tray base 11. The through hole 11b extends to the main surface on the side serving as an outer surface of the receptacle tray 14. The through hole 11b is for allowing both cleaning solution and rinsing liquid to pass therethrough and has a size preventing fall-off of the magnetic head slider 15.

In the tray base 11, fixing holes 11c as through holes extending between main surfaces are formed in plural positions (two positions in the illustrated example) so as to extend along one side of the tray base. An inwardly convex stepped portion 11d is formed along the peripheral edge of the base surface le. The illustrated shape of the stepped portion is for fitting the tray base 11 into the tray cover 12.

The tray cover 12 covers the tray base 11 lest the magnetic head sliders received in the recessed of the tray base 11 should jump out during cleaning for example. The tray cover 12 is formed in a plate shape and through holes 12b extending between main surfaces are formed in the tray cover 12 at positions corresponding to the recesses of the tray base 11 when the tray cover is fitted on the tray base. The through holes 12b are for passing both cleaning solution and rinsing liquid therethrough and each have a size preventing fall-off of the magnetic head slider 15.

In the tray cover 12, fixing holes 12c as through holes extending between main surfaces are formed in positions corresponding to the fixing holes 11c when the tray cover 12 is fitted on the tray base 11. The fixing holes 11c and 12c are used when the receptacle tray 14 is held by a tray holding element 50 to be described later. An inwardly concave stepped portion 12d is formed in the tray cover 12 along a cover surface 12e as a main surface on the side on which the tray cover is fitted on the tray base 11.

Thus, the receptacle tray 14 includes a combination of both tray base 11 and tray cover 12 described above. With the magnetic head sliders 15 received respectively within the recesses of the tray base 11, the stepped portion 11d of the tray base 11 and the stepped portion 12d of the tray cover 12 are fitted together in such a manner that the base surface 11e and the cover surface 12e confront each other.

The tray base 11 and the tray cover 12 thus fitted together are fixed with a clip 13 which holds the peripheral edge portions of the tray base and the tray cover. The clip 13 has a shape which does not close the accommodated portions of the magnetic head sliders 15, namely, the portions where the through holes 11b and 12b are formed.

In the receptacle tray 14 thus assembled, the fixing holes 11c and 12c are located in plural positions along one side of the tray and the receptacle tray 14 is made up of a slider non-accommodated area 60 which is used when the receptacle tray 14 is held by the tray holding element 50 (to be described later) and a slider accommodated area 61.

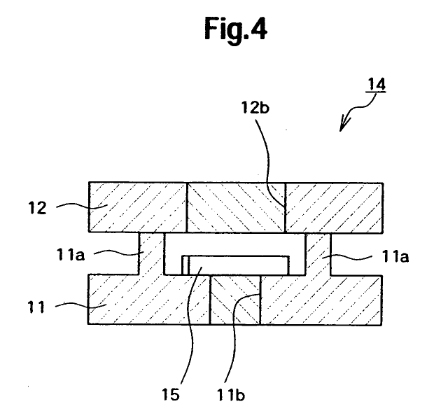

FIG. 4 illustrates the state of a magnetic head slider 15 accommodated within the receptacle tray 14. The magnetic head slider 15 is accommodated within a space formed by both a recess enclosed with partitioning portions 11a of the tray base 11 and the tray cover 12 which covers an opening of the recess. The configuration which thus encloses the magnetic head slider 15 is the receptacle portion for the magnetic head slider. The through holes 11b formed in the tray base 11 and the through holes 12b formed in the tray cover 12 are in communication with the interior of the receptacle portion from the exterior.

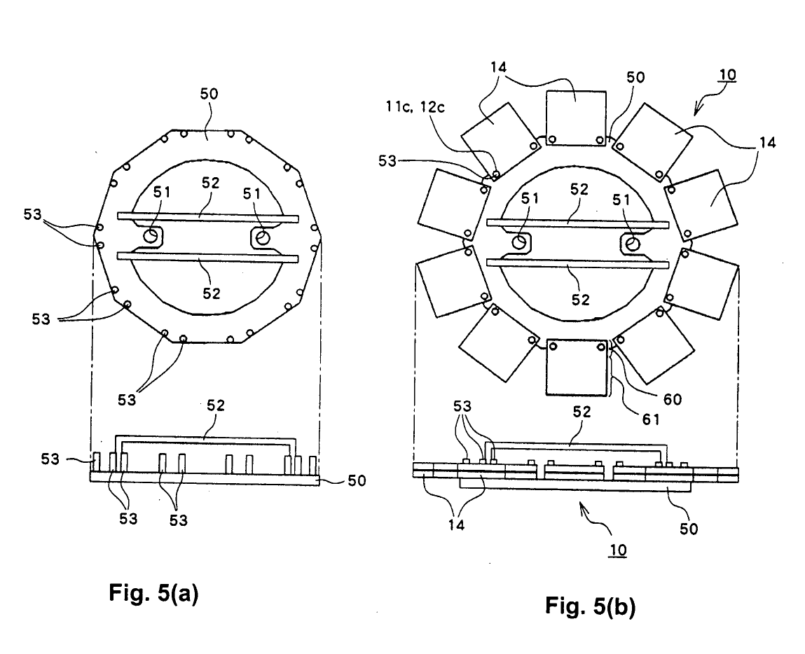

FIG. 5(A) shows the structure of the tray holding element 50 for holding the receptacle trays 14 and FIG. 5(B) illustrates in what state the receptacle trays 14 are held by the tray holding element 50 (the holder 10).

The tray holding element 50 is in the shape of an annular flat plate and is provided with plural tray holding pins 53 for holding the receptacle trays 14, the tray holding pins 53 being formed along the peripheral edge of the tray holding element 50. The tray holding pins 53 are inserted into the fixing holes 11c and 12c for the receptacle trays 14. The tray holding pins 53 are provided so that the tray holding piece 50 can hold ten receptacle trays 14, provided the number of the receptacle trays to be held is not limited thereto.

The tray holding element 50 is provided inside its annular portion with plural (two in the illustrated example) holding holes 51 to be used when the tray holding element is rotated in each of the blocks 2 to 4 and a handle 52 to be grasped by a conveyance mechanism during conveyance among the blocks 2 to 4.

The tray holding element 50 is used under rotation in each of the blocks 2 to 4 and its rotational center is positioned centrally of its annular portion. Therefore, the tray holding element 50 holds the receptacle trays 14 at positions away from the rotational center with use of the tray holding pins 53 which are formed along the peripheral edge of the annular portion. Consequently, with rotation of the tray holding element 50, the receptacle trays 14 revolve around the rotational center.

With the receptacle trays 14 held by the tray holding element 50, the slider accommodated area 61 which accommodates the magnetic head sliders 15 is positioned outside the annular portion. That is, since the tray holding pins 53 for the tray holding element 50 are inserted into the fixing holes 11c and 12c of the receptacle trays 14, only the slider non-accommodated areas 60 of the receptacle trays 14 in which areas the fixing holes 11c and 12c are positioned overlap the peripheral edge portion of the tray holding element 50, while the slider accommodated areas 61 with the magnetic head sliders 15 accommodated therein are open on both main surface sides. In other words, the through holes 11b and 12b formed in both main surfaces of the slider accommodated areas 61 are not shielded by the tray holding element 50.

A detailed description will be given below about each of the blocks 2 to 4 in the washing apparatus 100.

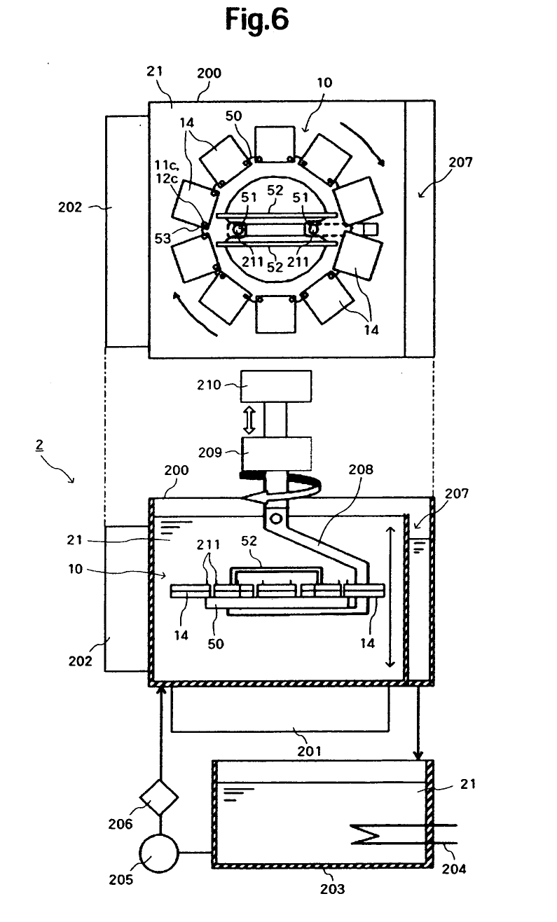

FIG. 6 illustrates a cleaning process performed by the cleaning block 2 in the cleaning apparatus 100. In the same figure, the lower side is a front view of the cleaning block 2, while the upper side is a top view thereof. In the cleaning block 2, the cleaning vessel 200 stores a cleaning solution 21 prepared by diluting a surface active agent with pure water. The cleaning solution 21 is not limited thereto. It may be a water or an oil-soluble solvent containing a surface active agent. Ultrasonic wave oscillators 201 and 202 for applying ultrasonic vibration to the cleaning solution 21 in the cleaning vessel 200 are attached to a side face and a bottom, respectively, of the cleaning vessel 200. The frequency of the ultrasonic wave to be applied to the cleaning solution 21 may be set at about 20 to 200 KHz (e.g., 170 KHz). The reason why the ultrasonic wave oscillators 201 and 202 are attached to a side face and the bottom of the cleaning vessel 200 is that it is intended to impart ultrasonic vibration uniformly to the cleaning solution 21 present within the cleaning vessel 200.

An overflow vessel 207 is formed sideways of the storage portion of the cleaning solution 21 in the cleaning vessel 200. The overflow vessel 207 feeds the cleaning solution 21 overflowing from the storage portion to a heating and filtering mechanism. The cleaning solution is fed from the overflow vessel 207 to a heating vessel 203 which underlies the cleaning vessel 200. A heater 204 for heating the cleaning solution 21 is installed in the heating vessel 203. The temperature for heating the cleaning solution 21 may be determined appropriately (e.g., 35° to 45° C.) in accordance with the degree of contamination of the article to be cleaned and properties of the cleaning solution. The cleaning solution 21 heated in the heating vessel 203 passes through a circulating pump 205 and is fed to a filter 206, whereby it is filtered. The cleaning solution 21 thus filtered by the filter 206 is returned to the heating vessel 203. Such a circulation of the cleaning solution 21 is performed by operation of the circulating pump 205.

In the cleaning block 2 is provided a rotary arm 208 which supports the holder 10 within the cleaning vessel 200. The holder 10 supported by the rotary arm 208 is immersed into the cleaning solution present within the cleaning vessel 200. The rotary arm 208 has holding pins 211. The holding pins 211 are inserted into the holding holes 51 of the tray holding element 50 in the holder 10, whereby the holder 10 is supported. The holder 10 is supported horizontally within the cleaning vessel 200. That is, the plate-like receptacle trays 14 and tray holding element 50 are in parallel with the bottom of the cleaning vessel 200.

The rotary arm 208 is connected to an arm rotating motor (rotating mechanism for washing) 209 which is installed above the cleaning vessel 200. With the arm rotating motor 209, the rotary arm 208 rotates together with the holder 10 which it supports. The holder 10 rotates horizontally along the peripheral edge of the tray holding element 50 as a plate-like element and the receptacle trays 14 revolve within the cleaning vessel 200. The arm rotating motor 209 is connected to a swing mechanism (swing mechanism for washing) 210. With the swing mechanism 210, the rotary arm 208 swings together with the holder 10 which it supports. The distance of the swing caused by the swing mechanism 210 can be set at about 10 to 300 mm (e.g., 80 mm). The holder 10 swings in the plate thickness direction of the tray holding element 50 as a plate-like element and the holding trays 14 move vertically through the interior of the cleaning vessel 200 from near the bottom of the vessel up to near the liquid level.

According to the cleaning operation described above the receptacle trays 14 move widely by revolution and vertical movement through the interior of the cleaning solution 21 with ultrasonic vibration applied thereto within the cleaning vessel 200. By such a wide movement of the receptacle trays 14 within the cleaning vessel 200, the influence of variations in strength distribution of the ultrasonic wave which are attributable to the layout positions of the ultrasonic wave oscillators, and like influence attributable to the standing wave, can be diminished to a minimum and it is possible to effect cleaning to a satisfactory extent.

Since there is no obstruction between the slider accommodated areas 61 of the receptacle trays 14 and the bottom, as well as the side faces, of the cleaning vessel 200, the ultrasonic vibration from the ultrasonic wave oscillators 201 and 201 attached to the bottom and a side face respectively of the cleaning vessel 200 is radiated sufficiently to the holder 10 supported within the cleaning vessel 200, thus making it possible to effect cleaning to a satisfactory extent.

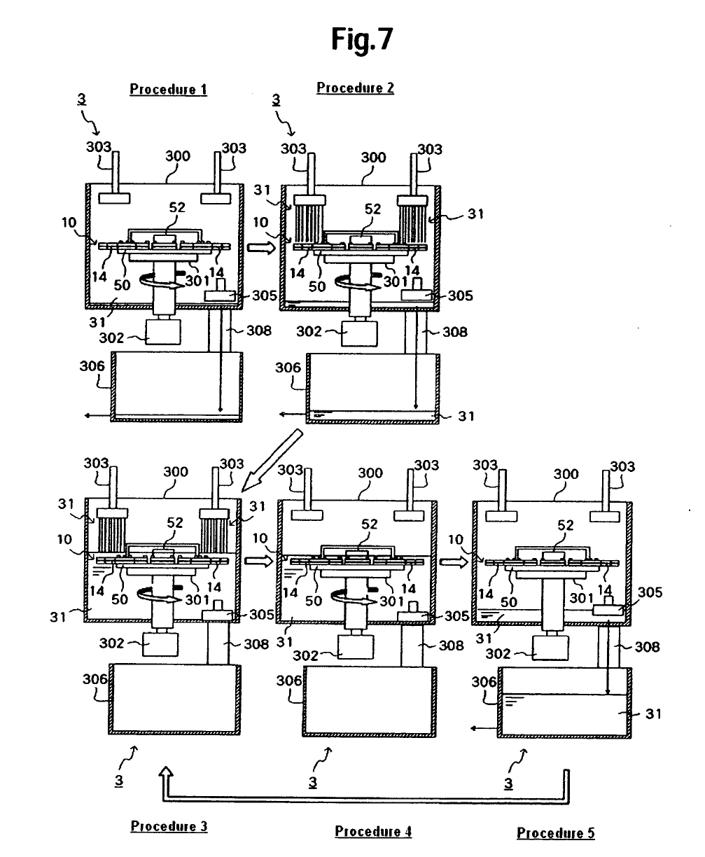

FIG. 7 illustrates a rinsing process performed by the rinsing block 3 in the cleaning apparatus 100. In the rinsing block 3, the rinsing vessel 300 stores rinsing liquid 31 which is pure water. The rinsing liquid 31 is not limited thereto. It may be a water or an oil-soluble solvent not containing a surface active agent. Such ultrasonic wave oscillators as in the cleaning vessel 200 described above are not attached to the rinsing vessel 300 and therefore ultrasonic vibration is not imparted to the rinsing liquid 31 stored in the rinsing vessel 300.

A disc-like rotary table 301 which supports the holder 10 is disposed within the rinsing vessel 300. The tray holding element 50 of the holder 10 is placed on the rotary table 301. The rotary table 301 is connected through a shaft to a rotating motor (rotating mechanism for rinsing) 302 which underlies the rinsing vessel 300. With the rotating motor 302, the rotary table 301 rotates together with the holder 10 which it supports. The holder 10 rotates horizontally along the peripheral edge of the tray holding element 50 as a plate-like element and the receptacle trays 14 revolve within the rinsing vessel 300.

Shower nozzles (liquid ejecting mechanisms) 303 are disposed in an upper portion of the rinsing vessel 300. The shower nozzles shower the rinsing liquid 31 onto the holder 10. The shower nozzles 303 are installed in a plural number (two in the illustrated example) so as to overlie the receptacle trays 14 on the holder 10 which is supported within the rinsing vessel 300. As the holder 10 rotates, the rinsing liquid 31 is ejected onto surfaces of all the receptacle trays 14 in which surfaces are formed through holes (through holes 12b in the illustrated example).

A valve 305 for discharge of the rinsing liquid 31 is disposed on the bottom of the rinsing vessel 300. When the valve 305 is opened, the rinsing liquid 31 present within the rinsing vessel 300 is discharged through a drain pipe 308 into a drainage tank 306 installed under the rinsing vessel 300.

The following description is now provided about a concrete flow of the rinsing process.

First, in Procedure 1, the holder 10 which has been conveyed from the cleaning block 2 after completion of the cleaning process is placed and fixed onto the rotary table 301 installed within the rinsing vessel 300. At this time, the valve 305 for drain installed in the bottom of the rinsing vessel 300 is kept open. In this state, the rotary motor 302 is turned ON to rotate the holder 10 together with the rotary table 301. For example, the rotary table 301 is rotated at a rate of about 50 to 250 revolutions per minute. By so doing, the cleaning solution adhering to the holder 10 and hence the cleaning solution adhering to the magnetic head sliders 15 accommodated in the receptacle trays 14 on the holder 10 can be shaken off. The cleaning solution thus shaken off drops to the bottom of the rinsing vessel 300 and is discharged to the drainage tank 306 through the valve 305 which is open. By performing this procedure, a component (e.g., a surface active agent) of the cleaning solution can be prevented insofar as possible from being mixed into the rinsing liquid 31 which is stored in the rinsing vessel 300 and used in Procedure 3 et seq.

Next, in Procedure 2, the holder 10 is rotated together with the rotary table 301 while the valve 305 is kept open and the rinsing liquid 31 is showered from the shower nozzles 303 onto the receptacle trays 14 of the holder 10 which is rotating. In this case, the rotary table 301 is rotated at a rate of, for example, about 5 to 20 revolutions per minute. As a result, the rinsing liquid 31 gets into the receptacle portion of each receptacle tray 14 from one through holes (here the through holes 12b) and flows out from the other through holes (here the through holes 11b), whereby the magnetic head sliders present within the receptacle portion of the receptacle tray can be rinsed. Further, by keeping the valve 305 open, the rinsing liquid 31 which has been used for rinsing drops to the bottom of the rinsing vessel 300 and is discharged into the drainage tank 306 through the open valve 305. By performing this procedure, a component (e.g., a surface active agent) of the cleaning solution can be prevented insofar as possible from being mixed into the rinsing liquid 31 which is stored in the rinsing vessel 300 and used in Procedure 3 and the subsequent procedure.

Next, in Procedure 3, the valve 305 is closed, the holder 10 is rotated together with the rotary table 301 and the rinsing liquid 31 is showered from the shower nozzles 303 onto the receptacle trays 14 on the holder 10 which is rotating. The rotary table 301 is here rotated at a rate of, for example, about 5 to 20 revolutions per minute. When the rinsing liquid 31 accumulates in the rinsing vessel 300 to the degree that the receptacle trays 14 of the holder 10 is immersed therein, the supply of the rinsing liquid 31 from the shower nozzles 303 is stopped. During the showering of the rinsing liquid 31, as noted above, the rinsing liquid 31 passes through the receptacle portion of each receptacle tray 14, so that the magnetic head sliders 15 present in the receptacle portion can be rinsed.

Next, in Procedure 4, the holder 10 is rotated together with the rotary table 301 in a state in which the receptacle trays 14 on the holder 10 are immersed in the rinsing liquid 31. As a result, the receptacle trays 14 revolve within the rinsing liquid 31. The rotary table is here rotated at a rate of, for example, about 80 to 130 revolutions per minute.

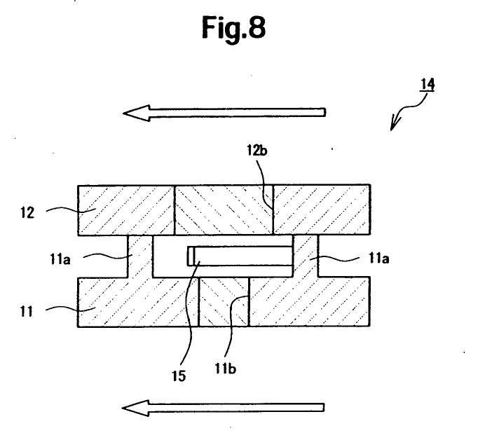

FIG. 8 shows the state of each magnetic head slider 15 in Procedure 4. The magnetic head slider 15 is accommodated within a receptacle portion formed by both a recess enclosed with the partitioning portions 11a of the tray base 11 and the tray cover 12 which covers an opening of the recess. When each receptacle tray 14 is immersed into the rinsing liquid 31, the interior of the receptacle portion is filled with the rinsing liquid 31 which has entered the receptacle portion from the through holes 11b and 12b. Consequently, the magnetic head slider 15 present within the receptacle portion becomes easier to fly over under a lifting force from the state in which it lies on the bottom within the receptacle portion (see FIG. 4). As a result, the rinsing liquid 31 comes into contact with the whole of the outer surface of the slider, thus making it possible to effect rinsing to a satisfactory extent.

Moreover, by immersing the receptacle tray 14 into the rinsing liquid 31, water pressure is applied to the magnetic head slider in the receptacle portion from the rinsing liquid 31 which has entered the receptacle portion, so that it is possible to effect rinsing to a satisfactory extent. Further, by revolving the receptacle tray 14 within the rinsing liquid 31, a high water pressure is applied to the magnetic head slider 15 in the receptacle portion from the rinsing liquid 31 which has entered the receptacle portion, whereby it is possible to effect rinsing to a satisfactory extent.

Within the rinsing liquid 31 the receptacle tray 14 revolves in a direction intersecting (here intersecting perpendicularly to) the extending direction of the through holes 11b and 12b, whereby the magnetic head slider 15 can be prevented from coming into abutment against the wall surfaces in which the through holes 11b and 12b are formed within the receptacle portion and it becomes easier to keep the magnetic head slider flying within the receptacle portion. It is also possible to prevent the magnetic head slider 15 from closing the through holes 11b and 12b within the receptacle portion and obstructing the flow of the rinsing liquid 31.

When the receptacle tray 14 is revolved in a direction intersecting the extending direction of the through holes 11b and 12b, the magnetic head slider 15 present within the receptacle portion approaches the rear side in the rotational direction and comes into abutment against a wall surface formed by a partitioning portion 11a, whereby the rinsing liquid 31 becomes difficult to enter the abutted portion. However, by periodically switching the rotational direction of the rotating motor 302 which rotates the holder 10, it is possible to let the rinsing liquid 31 contact the whole of the outer surface of the magnetic head slider 15 to a satisfactory extent.

Although in this embodiment each receptacle tray 14 is revolved within the rinsing liquid 31, this constitutes no limitation. The receptacle tray 14 may be held within flowing rinsing liquid. In both cases it is possible to obtain the same effect because the receptacle tray 14 is relatively moved with respect to the rinsing liquid 31.

Turning back to FIG. 7, in Procedure 5 as the next procedure, the drain valve 305 disposed on the bottom of the rinsing vessel 300 is opened to drain the rinsing liquid 31 stored in the rinsing vessel 300 into the drainage tank 306. When Procedure 5 is complete, a return is made to Procedure 3, then the operations of Procedures 3 to 5 described above are repeated plural times. By thus alternately performing Procedure 3 of showering the rinsing liquid 31 onto the receptacle tray 14 and Procedure 4 of revolving the receptacle tray 14 within the rinsing liquid 31 it is possible to thoroughly rinse each magnetic head slider 15 accommodated in the receptacle tray 14.

According to the rinsing operation described above the magnetic head sliders 15 accommodated with each receptacle tray 14 can be rinsed to a satisfactory extent without imparting ultrasonic vibration to the rinsing liquid 31 stored in the rinsing vessel 300. Since ultrasonic vibration is not applied to the rinsing liquid 31, a contaminant generated from the rinsing vessel 300 or the receptacle tray 14 will not adhere to the magnetic head slider 15 or air bubbles generated within the rinsing liquid 31 will not close the through holes 11b and 12b in the receptacle tray 14.

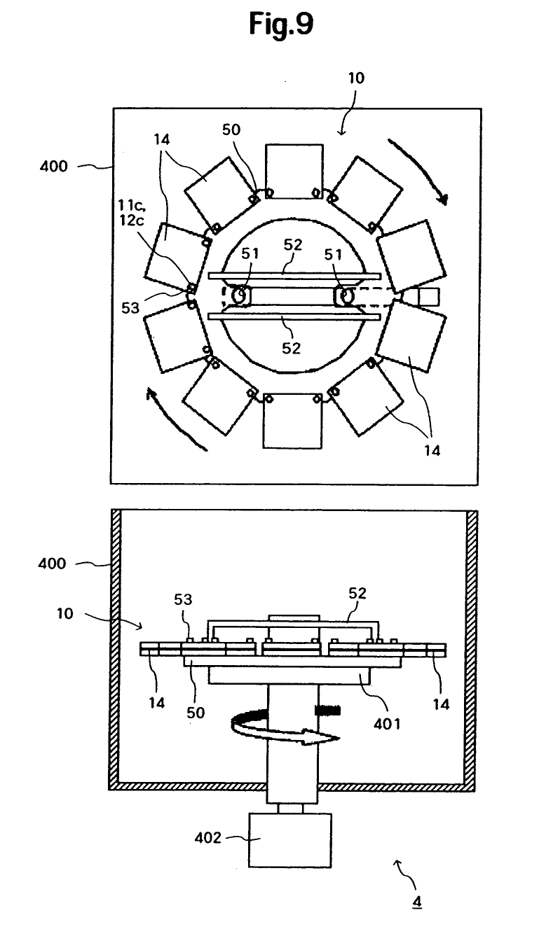

FIG. 9 illustrates a drying process performed by the drying block 4 in the cleaning apparatus 100. In the drying block 4 is provided a drying vessel 400 and within the drying vessel 400 is provided a disc-like rotary table 401 which supports the holder 10. The tray holding element 50 of the holder 10 is placed on the rotary table 401. The rotary table 401 is connected through a shaft to a rotating motor 402 which is disposed under the drying vessel 400.

With the rotating motor 402, the rotary table 401 rotates together with the holder 10 which it supports. The holder 10 rotates horizontally along the peripheral edge of the tray holding element 50 as a plate-like element. For example, the rotary table 401 is rotated at a rate of about 2000 to 3000 revolutions per minute. Since the receptacle trays 14 are held at positions away from the rotational center of the holder 10, the rinsing liquid adhering to the holder 10 and hence the rinsing liquid adhering to the magnetic head sliders 14 accommodated in the receptacle trays 14 on the holder 10 can be thoroughly shaken off and dried.

Although embodiments of the present invention have been described above, the present invention is not limited to the above embodiments.

For example, although in the above embodiments the cleaning process, rinsing process and drying process are performed in the cleaning block 2, rinsing block 3 and drying block 4, respectively, of the cleaning apparatus 100, no limitation is made thereto. Plural processes may be carried out in one block. More particularly, after completion of the rinsing process, the drain valve 305 disposed on the bottom of the rinsing vessel 300 may be opened to drain the rinsing liquid 31 and the drying process may be performed within the rinsing vessel 300 which has thus become empty. In this case, both rinsing process and drying process can be performed in the same block and it is not necessary to provide a block for the drying process separately.

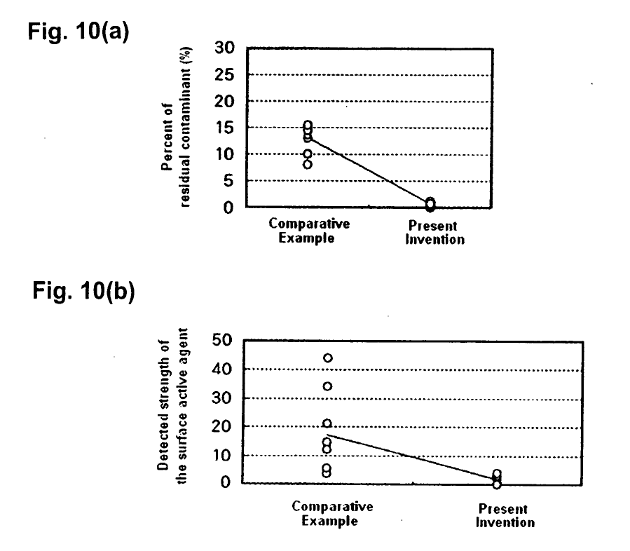

A description will be given below about the effect of the above embodiments of the present invention. FIG. 10 illustrates the results of cleaning and rinsing performed by the cleaning apparatus 100.

FIG. 10(A) illustrates the results of cleaning performed by the cleaning apparatus 100. A percent residual contaminant on magnetic head sliders was checked and is shown as the result of cleaning. As a comparative example, as in Patent Literature 1, magnetic sliders were accommodated in a cleaning basket and then the cleaning basket was allowed to swing within a cleaning vessel while ultrasonic vibration was applied to a cleaning solution. Other cleaning conditions were the same as in the present invention. As a result, the percent residual contaminant in the comparative example was 8% to 15%, while that in the embodiments of the present invention was not higher than 2%, and thus a marked difference is recognized between the two. Thus, the result of cleaning obtained in the embodiments of the present invention was better.

FIG. 10(B) illustrates the results of rinsing performed by the cleaning apparatus 100. A component (surface active agent) of a cleaning solution remaining on magnetic head sliders was analyzed by TOF-SIMS as highly sensitive organic analysis and the strength detected of the surface active agent is represented as the result of rinsing. As a comparative example, as in Patent Literature 2, magnetic head sliders were subjected to rinsing while an ultrasonic wave was applied into pure water as rinsing liquid. Cleaning and rinsing conditions were similar to embodiments of the present invention. As a result, the strength detected of the surface active agent in the comparative example was 3 to 44, while that in the embodiments of the present invention was not higher than 5, and thus a marked difference is recognized between the two. Thus, the result of rinsing obtained in the embodiments of the present invention was better.

According to the embodiments of the present invention, as set forth above, it is possible to clean and rinse a magnetic head slider to a satisfactory extent and hence possible to achieve a magnetic head slider having high cleanness. When mounted on a magnetic disk drive, the magnetic head slider thus obtained can exhibit stable flying performance and high durability. Consequently, it is possible to provide a magnetic disk drive of high reliability.

What is claimed is:

1. A method for cleaning a magnetic head slider, the method comprising:
a cleaning step of immersing a magnetic head slider in a cleaning solution with ultrasonic vibration applied thereto; and
a rinsing step of accommodating the magnetic slider within a receptacle portion of a receptacle tray, the receptacle tray having the receptacle portion for the magnetic head slider and at least two through holes communicating with the interior of the receptacle portion from the exterior, then immersing the receptacle tray into rinsing liquid and moving the receptacle tray within the rinsing liquid without applying ultrasonic vibration to the rinsing liquid.

2. The method for cleaning a magnetic head slider according to claim 1, wherein, in the rinsing step, the receptacle tray is moved in a direction intersecting an extending direction of the through holes within the rinsing liquid.

3. The method for cleaning a magnetic head slider according to claim 1, wherein, in the rinsing step, a procedure of ejecting the rinsing liquid onto the receptacle tray accommodating the magnetic head slider and a procedure of immersing the receptacle tray accommodating the magnetic head slider into the rinsing liquid and moving the receptacle tray within the rinsing liquid are performed in an alternate manner.

4. The method for cleaning a magnetic head slider according to claim 1, wherein the cleaning step involves immersing the receptacle tray with the magnetic head slider accommodated therein into the cleaning solution with the ultrasonic vibration applied thereto and moving the receptacle tray within the cleaning solution.

5. An apparatus for cleaning a magnetic head slider, the apparatus comprising:
a receptacle tray having a receptacle portion for a magnetic head slider and at least two through holes communicating with the interior of the receptacle portion from the exterior;
a tray holding element for holding the receptacle tray at a position spaced away from a rotational center of the tray holder;
a cleaning vessel for storing a cleaning solution;
an ultrasonic wave oscillator for applying ultrasonic vibration to the cleaning solution stored in the cleaning vessel;
a rotating mechanism for cleaning, the rotating mechanism for cleaning causing the tray holding element holding the receptacle tray to rotate in an immersed state within the cleaning solution stored in the cleaning vessel;
a rinsing vessel for storing rinsing liquid; and
a rotating mechanism for rinsing, the rotating mechanism for rinsing causing the tray holding element holding the receptacle tray to rotate in an immersed state within the rinsing liquid stored in the rinsing vessel.

6. The apparatus for cleaning a magnetic head slider according to claim 5, the apparatus further comprising
a swing mechanism for cleaning, the swing mechanism causing the tray holding element holding the receptacle tray to swing in an immersed state within the cleaning solution stored in the cleaning vessel in a rotational axis direction of the tray holding element being rotated by the rotating mechanism for cleaning.

7. The apparatus for cleaning a magnetic head slider according to claim 5, the apparatus further comprising a liquid ejecting mechanism for ejecting the rinsing liquid onto the receptacle tray within the rinsing vessel.
